(19) United States
(12) Patent Application Publication
(10) Pub. No.: US 2026/0045702 A1
(43) Pub. Date: Feb. 12, 2026

(54) RADIO WAVE ABSORPTION DEVICE AND DRIVING METHOD FOR RADIO WAVE ABSORPTION DEVICE

(71) Applicant: Japan Display Inc., Tokyo (JP)

(72) Inventors: Kazuki MATSUNAGA, Tokyo (JP); Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 19/363,703

(22) Filed: Oct. 21, 2025

Related U.S. Application Data
(63) Continuation of application No. PCT/JP2024/007060, filed on Feb. 27, 2024.

(30) Foreign Application Priority Data
May 12, 2023 (JP) 2023-079416

(51) Int. Cl. H01Q 17/00

(52) U.S. Cl. CPC H01Q 17/007

(57) ABSTRACT

A radio wave absorption device includes a first substrate including a first surface and a second surface opposite the first surface, a first electrode arranged on the first surface, a second substrate including a third surface and a fourth surface opposite the third surface, a second electrode arranged on the third surface, a liquid crystal layer arranged between the first electrode and the fourth surface, and a control circuit configured to supply a first voltage to the first electrode, a second voltage to the second electrode, and adjustably to control the propagation length of the radio waves to be absorbed according to the first voltage and the second voltage.

### CROSS-REFERENCE TO RELATED APPLICATIONS

This application is a Continuation of International Patent Application No. PCT/JP2024/007060, filed on Feb. 27, 2024, which claims the benefit of priority to Japanese Patent Application No. 2023-079416, filed on May 12, 2023, the entire contents of each are incorporated herein by reference.

### FIELD

An embodiment of the present invention relates to a radio wave absorption device and a driving method for the radio wave absorption device.

Conventionally, electromagnetic waves generated from inside an electronic device housing may deteriorate the performance of surrounding electronic devices, and electromagnetic waves generated from surrounding electronic devices may deteriorate the performance of electronic devices. For example, the deterioration in performance is a malfunction. An example of a member capable of suppressing the deterioration in performance of an electronic device due to electromagnetic waves is a radio wave absorber. The radio wave absorber is a material having a function of converting energy of an incident radio wave into thermal energy and suppressing reflection and transmission of the electromagnetic wave. For example, by arranging the radio wave absorber in the vicinity of the electronic device, the radio wave absorber absorbs electromagnetic waves that adversely affect the electronic device, and the radio wave absorber can suppress the deterioration in performance of the electronic device.

For example, a radio wave absorber is known in which Li—Zn ferrite is dispersed in a resin having a relative dielectric constant of 4.9 or less in a radio wave frequency range of 1 MHz or more. In addition, for example, a radio wave absorber having a radio wave absorbing layer composed of a radio wave absorbing material containing W-type hexagonal ferrite powder and a matrix (for example, rubber, resin, inorganic binder, inorganic/organic hybrid binder, and the like) is known.

### SUMMARY

A radio wave absorption device includes a first substrate including a first surface and a second surface opposite the first surface, a first electrode arranged on the first surface, a second substrate including a third surface and a fourth surface opposite the third surface, a second electrode arranged on the third surface, a liquid crystal layer arranged between the first electrode and the fourth surface, and a control circuit configured to supply a first voltage to the first electrode, a second voltage to the second electrode, and adjustably to control propagation lengths of radio waves to be absorbed according to the first voltage and the second voltage.

A driving method for a radio wave absorption device including a first substrate including a first surface and a second surface opposite the first surface, a first electrode arranged on the first surface, a second substrate including a third surface and a fourth surface opposite the third surface, a second electrode arranged on the third surface, a liquid crystal layer arranged between the first electrode and the fourth surface, and the driving method includes supplying a first voltage to the first electrode, supplying a second voltage lower than the first voltage to the second electrode, and adjusting the propagation length of the radio wave of the predetermined frequency according to the first voltage and the second voltage.

### BRIEF DESCRIPTION OF DRAWINGS

FIG. 1 is a plan view showing a configuration of a radio wave absorption device according to the first embodiment of the present invention.

FIG. 2 is a cross-sectional view showing an example of a cross-sectional structure taken along a line A1-A2 shown in FIG. 1.

FIG. 3 is a cross-sectional view showing an example of a cross-sectional structure of a radio wave absorption device according to the first embodiment of the present invention.

FIG. 4 is an equivalent circuit diagram of a radio wave absorption device according to the first embodiment of the present invention.

FIG. 5 is a diagram schematically showing that a radio wave absorption device according to the first embodiment of the present invention absorbs radio waves.

FIG. 6 is a diagram showing a state in which no voltage is applied between a bias electrode and a first common electrode in a radio wave absorption device according to the first embodiment of the present invention.

FIG. 7 is a diagram showing a state in which a voltage is applied between a bias electrode and a first common electrode in a radio wave absorption device according to the first embodiment of the present invention.

FIG. 8 is a diagram showing a state in which a voltage is applied between a bias electrode and a first common electrode in a radio wave absorption device according to the first embodiment of the present invention.

FIG. 9 is a schematic graph showing a relationship between a frequency and the amount of radio wave absorption of the radio wave absorption device according to the first embodiment of the present invention.

FIG. 10 is a schematic graph showing a relationship between a frequency and the amount of radio wave absorption of the radio wave absorption device according to the first embodiment of the present invention.

FIG. 11 is a plan view showing a configuration of a radio wave absorption device according to the second embodiment of the present invention.

FIG. 12 is a cross-sectional view showing an example of a cross-sectional structure taken along a line B1-B2 shown in FIG. 11.

FIG. 13 is a diagram showing a state in which a voltage is applied between a bias electrode, a first common electrode, and a second common electrode in a radio wave absorption device according to the second embodiment of the present invention.

FIG. 14 is an equivalent circuit diagram of a radio wave absorption device according to the second embodiment of the present invention.

### DESCRIPTION OF EMBODIMENTS

On the other hand, in the case where a radio wave absorber is arranged in the vicinity of an electronic device, from the perspective of security or work safety, a thin and transparent radio wave absorber is required to improve the visibility of a space in which the electronic device and the radio wave absorber are arranged. However, the radio wave absorbers described in Cited Documents 1 and 2 are difficult to be made thin and transparent.

In view of the problem, an object of an embodiment of the present invention is to provide a radio wave absorber that can be made thin and transparent, a radio wave absorption device including the radio wave absorber, and a driving method for the radio wave absorption device.

Hereinafter, embodiments of the present invention will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but are merely examples, and do not limit the interpretation of the present invention. Further, in the present specification and the drawings, elements similar to those described above with respect to the above-described figures are denoted by the same reference signs (or reference signs denoted by a, b, and the like) and detailed description thereof may be omitted as appropriate. Furthermore, the letters “first” and “second” with respect to the respective elements are convenient signs used to distinguish the respective elements, and do not have any further meaning unless otherwise specified.

In the present specification, a member or region is “on (or under)” another member or region, including, without limitation, when it is directly above (or below) the other member or region, but also when it is above (or below) the other member or region, that is, when another component is included between above (or below) the other member or region.

In the present specification, a direction D1 intersects a direction D2, and a direction D3 intersects the direction D1 and the direction D2 (D1D2 plane). The direction D1 is referred to as a first direction, the direction D2 is referred to as a second direction, and the direction D3 is referred to as a third direction. For example, the direction D1, the direction D2, and the direction D3 correspond to a direction X (direction x), a direction Y (direction y), and a direction Z (direction z).

In the present specification, in the case where the expressions “the same” and “coincident” are used, “the same” and “coincident” may include errors within the design range.

### First Embodiment

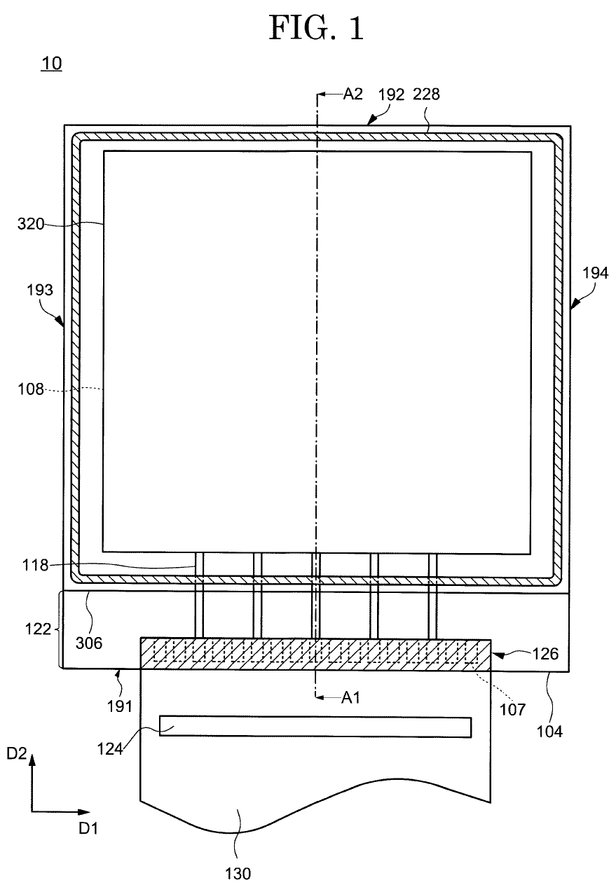

A radio wave absorption device 10 according to the first embodiment will be described with reference to FIG. 1 to FIG. 10. The radio wave absorption device 10 is a device having a function of absorbing radio waves by utilizing a change in the dielectric constant due to an alignment state of a liquid crystal.

### 1-1. Overview of Radio Wave Absorption Device 10

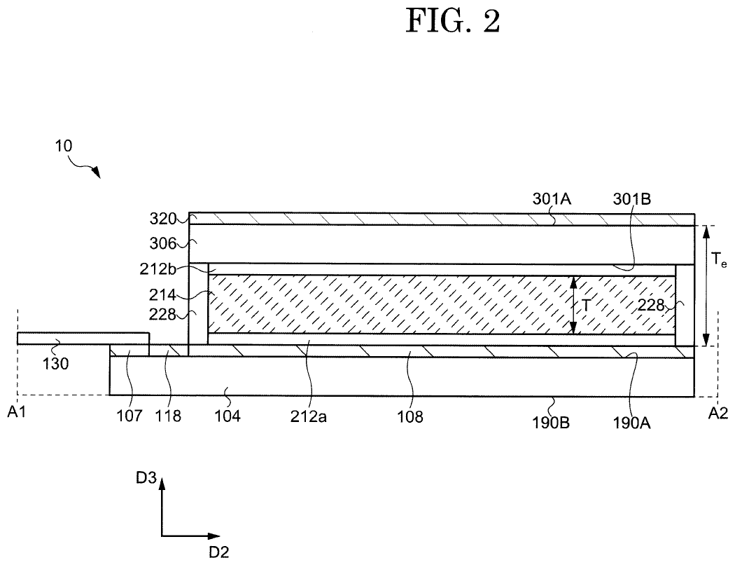

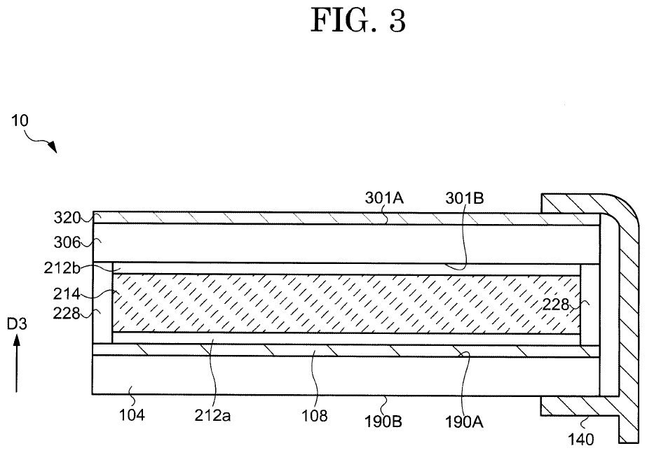

An overview of the radio wave absorption device 10 will be described with reference to FIG. 1 to FIG. 3. FIG. 1 is a plan view showing a configuration of the radio wave absorption device 10. FIG. 2 is a cross-sectional view showing an example of a cross-sectional structure taken along a line A1-A2 shown in FIG. 1. FIG. 3 is a cross-sectional view showing an example of a cross-sectional structure of the radio wave absorption device 10.

As shown in FIG. 1, the radio wave absorption device 10 includes a dielectric substrate 104 including a first surface 190A and a second surface 190B opposite the first surface 190A, a bias electrode 108 arranged on the first surface 190A, a plurality of control signal lines 118 electrically connected to the bias electrode 108, a counter substrate 306 including a first surface 301A and a second surface 301B opposite the first surface 301A, a first common electrode 320 arranged on the first surface 301A, a liquid crystal layer 214 sandwiched between the bias electrode 108 and the second surface 301B, and a control circuit 124 electrically connected to the bias electrode 108 (the control signal line 118) and the first common electrode 320. The dielectric substrate 104 may be referred to as a first substrate, the first surface 190A may be referred to as a first surface, the second surface 190B may be referred to as a second surface, the counter substrate 306 may be referred to as a second substrate, the first surface 301A may be referred to as a third surface, the second surface 301B may be referred to as a fourth surface, a bias electrode 108 may be referred to as a first electrode, and the first common electrode 320 may be referred to as a second electrode.

Although details will be described later, a driving method for the radio wave absorption device 10 includes supplying a common voltage to the first common electrode 320 and transmitting a predetermined control signal to the bias electrode 108 (the control signal line 118). For example, the control circuit 124 supplies a common voltage to the first common electrode 320 and transmits the predetermined control signal to the bias electrode 108 (the control signal line 118). For example, the common voltage is a ground voltage (GND voltage), and the predetermined control signal is a control signal SIG (V₁).

For example, the control signal includes a voltage V₁. For example, the common voltage may be a common voltage (voltage COM), the ground voltage (GND voltage), a 0 V voltage, or a voltage VSS. The voltage V₁ is greater than the common voltage.

The dielectric constant of the liquid crystal layer 214 can be changed, the apparent propagation length of an incident radio wave (incident wave) can be changed, and the apparent distance (thickness Tₑ) between the first common electrode 320 and the bias electrode 108 can be adjusted, by supplying the voltage COM to the first common electrode 320 and supplying the voltage V₁ to the bias electrode 108 (the control signal line 118) in the driving method for the radio wave absorption device 10. Since the liquid crystal layer 214 has dielectric anisotropy, it can be regarded as a variable dielectric layer. The driving method for the radio wave absorption device 10 includes adjusting a voltage supplied to the first common electrode 320 and the bias electrode 108 (the control signal line 118), and the radio wave absorption device 10 functions as a variable impedance in which the liquid crystal layer 214 is sandwiched between the first common electrode 320 and the bias electrode 108. As a result, the apparent thickness Tₑ between the first common electrode 320 and the bias electrode 108 changes, and the radio wave absorption device 10 can change and adjust the frequency (propagation length) of the radio wave absorbed by the radio wave absorption device 10.

For example, in a process of manufacturing the radio wave absorber, a frequency absorbed by the radio wave absorber may deviate from a predetermined frequency according to manufacturing variations of a member forming the radio wave absorber. On the other hand, the radio wave absorption device 10 can adjust the voltage supplied to the first common electrode 320 and the bias electrode 108 (the control signal line 118), adjust the frequency of the radio wave to be absorbed, and correct manufacturing variations (errors).

### 1-2. Configuration of Radio Wave Absorption Device 10

The configuration of the radio wave absorption device 10 will be described in more detail with reference to FIG. 1, FIG. 2, or FIG. 3. In addition, descriptions of the same or similar configurations as those in FIG. 1 may be omitted.

As shown in FIG. 1, FIG. 2, or FIG. 3, the radio wave absorption device 10 includes the dielectric substrate 104, the counter substrate 306, and a peripheral region 122. In addition, the radio wave absorption device 10 includes a first alignment film 212a, a sealing material 228, a second alignment film 212b, and a metal member 140 of a housing.

The radio wave absorption device 10 (the dielectric substrate 104) has a first side 191 along the direction D1, a third side 193 intersecting the first side 191 along the direction D2, a second side 192 intersecting the third side 193 and facing the first side 191 in parallel, and a fourth side 194 intersecting the first side 191 and the second side 192 and facing the third side 193 in parallel. The counter substrate 306 overlaps the dielectric substrate 104, and the counter substrate 306 is bonded to the dielectric substrate 104 using the sealing material 228. A region surrounded by the counter substrate 306, the dielectric substrate 104, and the sealing material 228 includes the liquid crystal layer 214.

A region of the dielectric substrate 104 except that the dielectric substrate 104 and the counter substrate 306 overlap each other is referred to as the peripheral region 122. The peripheral region 122 includes a terminal section 126 that includes a portion of the plurality of control signal lines 118 and a plurality of terminals 107.

The terminal section 126 including the bias electrode 108, the plurality of control signal lines 118, and the plurality of terminals 107 is arranged on the first surface 190A. In addition, the bias electrode 108 shown in FIG. 1 or FIG. 2 is arranged on a portion of the first surface 190A of the dielectric substrate 104 to overlap the liquid crystal layer 214 inside the sealing material 228, but the bias electrode 108 may be arranged on the entire surface on the first surface 190A.

The terminal section 126 is a region for forming a connection with an external circuit. For example, an FPC (Flexible Printed Circuit) 130 is connected to the terminal section 126. The terminal section 126 receives a signal for controlling the control circuit 124 from the FPC 130.

The control circuit 124 is arranged on the FPC 130 using a COF (Chip on Film) method. The control circuit 124 receives power and control signals from the external circuit. For example, the control circuit 124 includes a circuit (voltage adjustment circuit) for adjusting a voltage to be supplied to each of the plurality of control signal lines 118 based on the power or control signals supplied from the external circuit. The control circuit 124 supplies each signal adjusted using the voltage adjustment circuit to each of the plurality of control signal lines 118. For example, the signals adjusted using the voltage regulating circuit are the voltage V₁, the control signal SIG (V₁), and the like.

The plurality of control signal lines 118 arranged in the dielectric substrate 104 extends in the direction D2 and extends in the peripheral region 122 and is connected to the terminal 107.

The first common electrode 320 arranged on the first surface 301A of the counter substrate 306 is arranged in the direction D1 and the direction D2, and is connected to the metal member 140 of the housing. The metal member 140 of the housing sandwiches the first common electrode 320 arranged on the first surface 301A of the counter substrate 306 and the second surface 190B of the dielectric substrate 104. For example, the metal member 140 of the housing is connected to a ground (GND) terminal. The GND voltage is supplied from the GND terminal to the first common electrode 320 via the metal member 140 of the housing.

A cross-sectional structure of the radio wave absorption device 10 will be described with reference to FIG. 2 or FIG. 3. The first common electrode 320 is provided on the first surface 301A of the counter substrate 306. The second alignment film 212b is provided on the second surface 301B of the counter substrate 306. The surface of the dielectric substrate 104 on which the bias electrode 108 is provided is arranged to face the first surface 301A of the counter substrate 306. The liquid crystal layer 214 is provided in a region surrounded by the first alignment film 212a, the second alignment film 212b, and the sealing material 228. Although not shown, a spacer to maintain a constant interval may be provided between the dielectric substrate 104 and the counter substrate 306.

For example, the thickness T of the liquid crystal layer 214 may be 20 μm or more and less than 50 μm, and typically 30 μm or more and less than 40 μm. For example, the thickness T of the liquid crystal layer 214 of the radio wave absorption device 10 is 35 μm.

For example, a rigid substrate having light transmittance, such as a glass substrate, a quartz substrate, a sapphire substrate, or the like, is used as the dielectric substrate 104 and the counter substrate 306. For example, in the first embodiment, the glass substrate is used as the dielectric substrate 104 and the counter substrate 306.

The bias electrode 108 is formed of a material capable of reflecting radio waves. For example, the bias electrode 108, the control signal line 118, and the terminal 107 are formed using a metal material, such as titanium (Ti), aluminum (Al), molybdenum (Mo), or copper (Cu). For example, the bias electrode 108, the control signal line 118, and the terminal 107 may be composed of a stacked structure of titanium (Ti)/aluminum (Al)/titanium (Ti), or a stacked structure of molybdenum (Mo)/aluminum (Al)/molybdenum (Mo). Similar to the bias electrode 108, the first common electrode 320 is formed of a material capable of reflecting radio waves. For example, the first common electrode 320 is formed of a metal film, such as aluminum (Al) or copper (Cu), or a transparent conductive film, such as indium tin oxide (ITO). For example, the first common electrode 320 of the radio wave absorption device 10 is formed of the ITO.

A glass substrate having light transmittance can be used as the dielectric substrate 104 and the counter substrate 306, and an ITO having a thin transparent conductive film can be used as the first common electrode 320, so that the radio wave absorption device 10 can be made thin and transparent.

### 1-3. Equivalent Circuit of Radio Wave Absorption Device 10

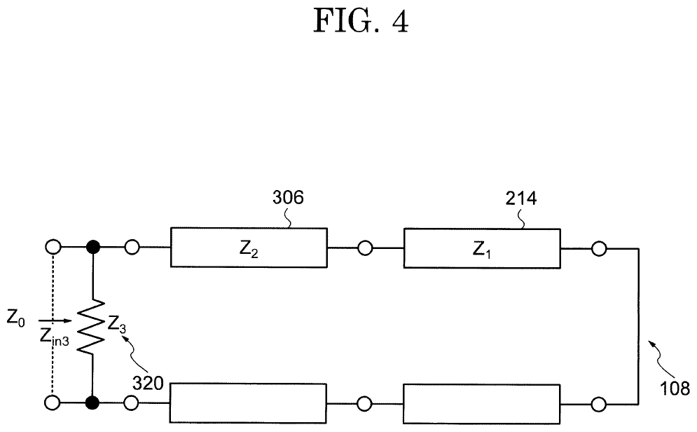

An equivalent circuit of the radio wave absorption device 10 will be described with reference to FIG. 4. FIG. 4 is an equivalent circuit diagram of the radio wave absorption device 10. In addition, descriptions of the same or similar configurations as those in FIG. 1 to FIG. 3 may be omitted.

The equivalent circuit of the radio wave absorption device 10 can be shown in FIG. 4 using an impedance Z₃ of the first common electrode 320, an impedance Z₂ of the counter substrate 306, an impedance Z₁ of the liquid crystal layer 214, and the short-circuited bias electrode 108. An input impedance Zᵢₙ₃ is an input impedance Zᵢₙ₃ expected from the front surface of the radio wave absorption device 10.

In this case, the surface resistance value of the first common electrode 320 is made to coincide with a characteristic impedance Z₀ of air. In this case, a reflectance ┌ is expressed by the following Equation (1). The condition in which the radio wave absorption device 10 absorbs (does not reflect) the radio wave is ┌=0. That is, the input impedance Zᵢₙ₃ of the radio wave absorption device 10 is designed to satisfy Equation (2).

$$\begin{matrix}Equation ( 1 ) & \\ Γ = \frac{{Z}_{i n 3} - {Z}_{0}}{{Z}_{i n 3} + {Z}_{0}} & ( 1 )\end{matrix}$$

$$\begin{matrix}Equation ( 2 ) & \\ {Z}_{in 3} = {Z}_{0} & ( 2 )\end{matrix}$$

### 1-4. Overview of Operation of Radio Wave Absorption Device 10

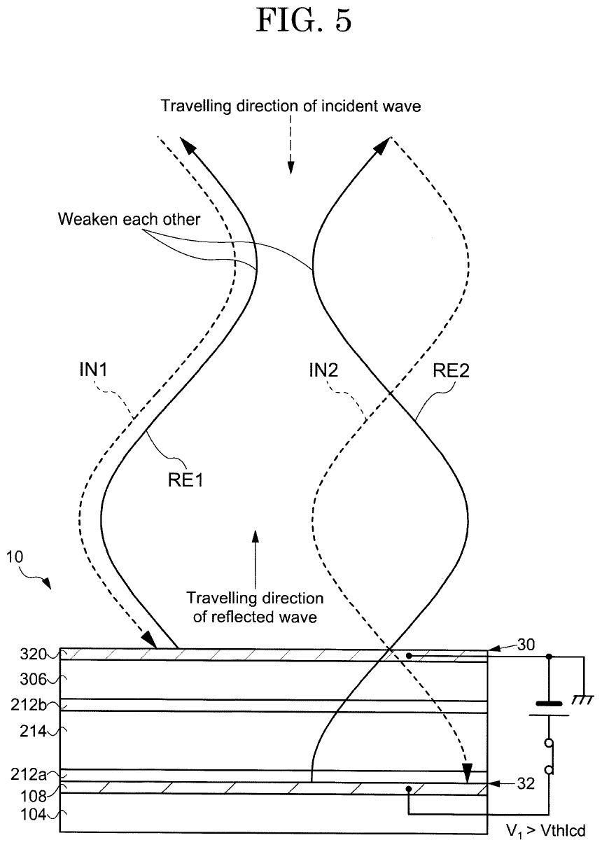

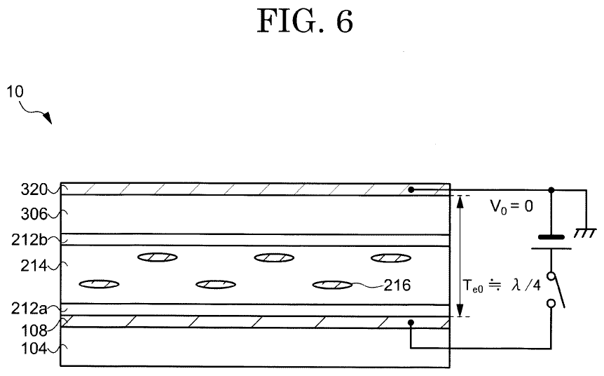

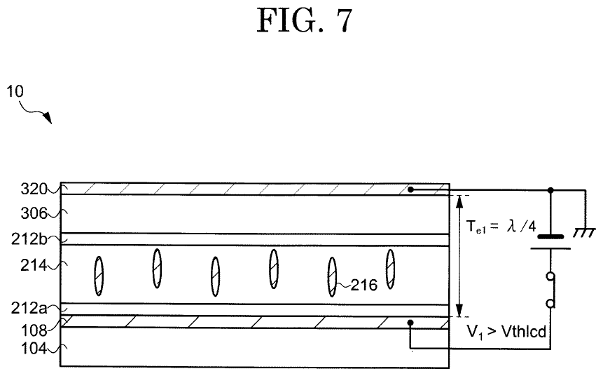

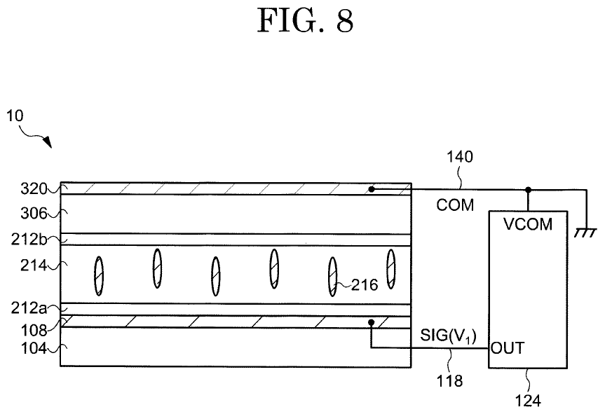

An overview of an operation of the radio wave absorption device 10 will be described with reference to FIG. 2 and FIG. 5 to FIG. 8. FIG. 5 is a diagram schematically showing that the radio wave absorption device 10 absorbs radio waves, FIG. 6 is a diagram showing a state in which no voltage is applied between the bias electrode 108 and the first common electrode 320 in the radio wave absorption device 10, and FIG. 7 is a diagram showing a state in which a voltage is applied between the bias electrode 108 and the first common electrode 320 in the radio wave absorption device 10. FIG. 8 is a diagram showing a state in which a voltage is applied between the bias electrode 108 and the first common electrode 320 in the radio wave absorption device 10. Descriptions of the same or similar configurations as those in FIG. 1 to FIG. 4 will be omitted.

There is no restriction on the frequency of radio waves that can be absorbed by the radio wave absorption device 10. For example, the radio wave absorption device 10 can absorb radio waves in the range of 44 GHZ to 53 GHZ.

For example, as shown in FIG. 2, the radio wave absorption device 10 includes a configuration in which the first common electrode 320 is arranged at a position separated by the thickness Tₑ from the bias electrode 108 at the design stage.

The control signal SIG (V₁) for controlling the alignment of a liquid crystal molecule 216 of the liquid crystal layer 214 is transmitted to the bias electrode 108 (FIG. 8). For example, the control signal SIG (V₁) is a signal of a DC voltage or a polarity-inverted signal in which a positive DC voltage and a negative DC voltage are alternately inverted. For example, the radio wave absorption device 10 transmits the polarity-inverted signal as shown in FIG. 5 to the bias electrode 108. For example, the voltage COM is supplied to the first common electrode 320 of the radio wave absorption device 10. For example, the voltage COM is an intermediate-level voltage of the polarity-inverted signal.

When a potential difference occurs between the first common electrode 320 and the bias electrode 108, an alignment state of the liquid crystal molecule 216 contained in the liquid crystal layer 214 changes. In addition, a signal obtained by inverting the phase of the control signal supplied to the bias electrode 108 may be supplied to the first common electrode 320.

In this case, the radio wave absorption device 10 reflects the radio wave at a surface 30 (a surface opposite a surface of the first common electrode 320 in contact with the counter substrate 306) in a traveling direction of a reflected wave RE1 as shown in FIG. 5, relative to a traveling direction of an incident wave IN1 as shown in FIG. 5. In addition, the radio wave absorption device 10 reflects a radio wave at a surface 32 (a surface of the bias electrode 108 in contact with the first alignment film 212a) in a traveling direction of a reflected wave RE2 as shown in FIG. 5, relative to a traveling direction of an incident wave IN2 as shown in FIG. 5. The surface 30 may be referred to as a first reflecting surface, and the surface 32 may be referred to as a second reflecting surface.

For example, the thickness Tₑ at the design stage is a wavelength λ/4 (one-fourth of the wavelength λ). At the manufacturing stage, in the case where the thickness Tₑ deviates from the wavelength λ/4, the radio wave absorption device 10 adjusts the voltage V₁ supplied between the first common electrode 320 and the bias electrode 108 to a voltage greater than a threshold V_{thlcd} of the liquid crystal layer 214, and can adjust (correct) the frequency of the radio wave to be absorbed so that the thickness Tₑ becomes the wavelength └/4. That is, the radio wave absorption device 10 can adjust (correct) the frequency of the radio wave to be absorbed so that the phase of the reflected wave RE1 at the first common electrode 320 and the phase of the reflected wave RE2 at the bias electrode 108 are shifted by 180 degrees (IT radians) and the radio waves are weakened (canceled) from each other.

In FIG. 6, for example, a thickness Tₑ₀ of the radio wave absorption device 10 is a value near the wavelength λ/4 (Te0≈λ/4) deviated from the wavelength λ/4. FIG. 6 shows a state in which a voltage V₀=0 V is applied to the first common electrode 320 and no voltage is applied to the bias electrode 108. That is, FIG. 6 shows a state in which no voltage difference occurs between the bias electrode 108 and the first common electrode 320 (referred to as a “first state”). FIG. 6 shows the case where the first alignment film 212a and the second alignment film 212b are horizontal alignment films. The long axis of the liquid crystal molecule 216 in the first state is aligned horizontally with respect to the front surface of the bias electrode 108 by the first alignment film 212a and the second alignment film 212b.

FIG. 7 shows a state in which the voltage V₀=0 V is applied to the first common electrode 320, and the control signal SIG (V₁) including the voltage V₁ greater than the threshold V_{thlcd} of the liquid crystal layer 214 is transmitted to the bias electrode 108 (referred to as a “second state”). For example, in FIG. 7, a thickness Tₑ₁ of the radio wave absorption device 10 is adjusted to a wavelength λ/4 (Tₑ₁=λ/4). For example, in the second state, the liquid crystal molecule 216 is subjected to an electric field so that the long axis is aligned perpendicular to the surface of the bias electrode 108. An angle of the long axis of the liquid crystal molecule 216 may be aligned, depending on the magnitude of the control signal SIG (V₁) supplied to the bias electrode 108, in an intermediate direction between the horizontal and vertical directions. In the case where the liquid crystal molecule 216 has a positive dielectric anisotropy, the apparent dielectric constant in the second state is greater than that in the first state.

For example, as shown in FIG. 8, the control circuit 124 includes a terminal VCOM and a terminal OUT. The terminal VCOM is electrically connected to the metal member 140 of the housing and the first common electrode 320. The terminal OUT is electrically connected to the control signal line 118 and the bias electrode 108. The terminal VCOM, the metal member 140 of the housing, and the first common electrode 320 are grounded and supplied with, for example, a voltage V₀ or a COM voltage. The control circuit 124 transmits the control signal SIG (V₁) including the voltage V₁ to the control signal line 118 and the bias electrode 108. The voltage supplied to the control signal line 118 and the bias electrode 108 is referred to as a first voltage, and the voltage supplied to the terminal VCOM, the metal member 140 of the housing, and the first common electrode 320 is referred to as a second voltage. The voltage V₁ is greater than the voltage V₀. In addition, the voltage V₁ or a potential difference between the voltage V₁ and the voltage V₀ is greater than the threshold V_{thlcd} of the liquid crystal layer 214. The liquid crystal layer 214 threshold V_{thccd} is a voltage at which the liquid crystal layer 214 begins to align.

### 1-5. Example of Driving Method for Radio Wave Absorption Device 10

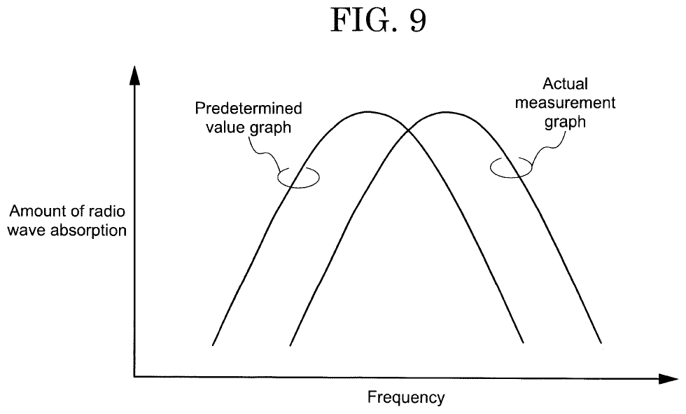

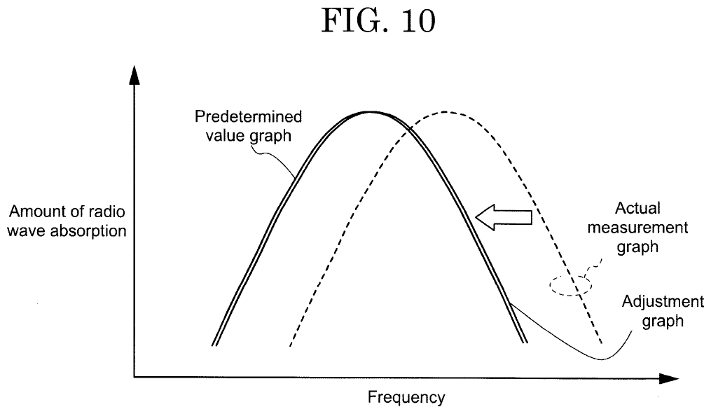

An example of the driving method for the radio wave absorption device 10 will be described with reference to FIG. 9 and FIG. 10. FIG. 9 and FIG. 10 are schematic graphs showing a relationship between the frequency and the amount of radio wave absorption of the radio wave absorption device 10. Descriptions of the same or similar configurations as those in FIG. 1 to FIG. 8 will be omitted.

For example, a predetermined value graph shown in FIG. 9 is a schematic graph showing a relationship between the frequency and the amount of radio wave absorption of the radio wave absorption device 10 in which thickness Tₑ is designed to be the wavelength λ/4, and the actual measurement graph shown in FIG. 9 is a schematic graph showing a relationship between the frequency and the amount of radio wave absorption of the radio wave absorption device 10 after manufacturing. As shown in FIG. 9, the actual measurement graph of the radio wave absorption device 10 is deviated from the predetermined value graph.

For example, as described in “1-4. Overview of Operation of Radio Wave Absorption Device 10”, the driving method for the radio wave absorption device 10 includes supplying the COM voltage to the terminal VCOM, the metal member 140 of the housing, and the first common electrode 320, and supplying the control signal SIG (V₁) including the voltage V₁ to the bias electrode 108.

As shown in FIG. 10, the radio wave absorption device 10 adjusts the absorption of the radio wave by using the driving method for the radio wave absorption device 10, so that an actual measurement graph after manufacturing can be adjusted to an adjustment graph. In FIG. 10, although the adjustment graph is deviated from the predetermined value graph to make the graph easy to see, the driving method for the radio wave absorption device 10 can be adjusted so that the adjustment graph overlaps the predetermined value graph.

### Second Embodiment

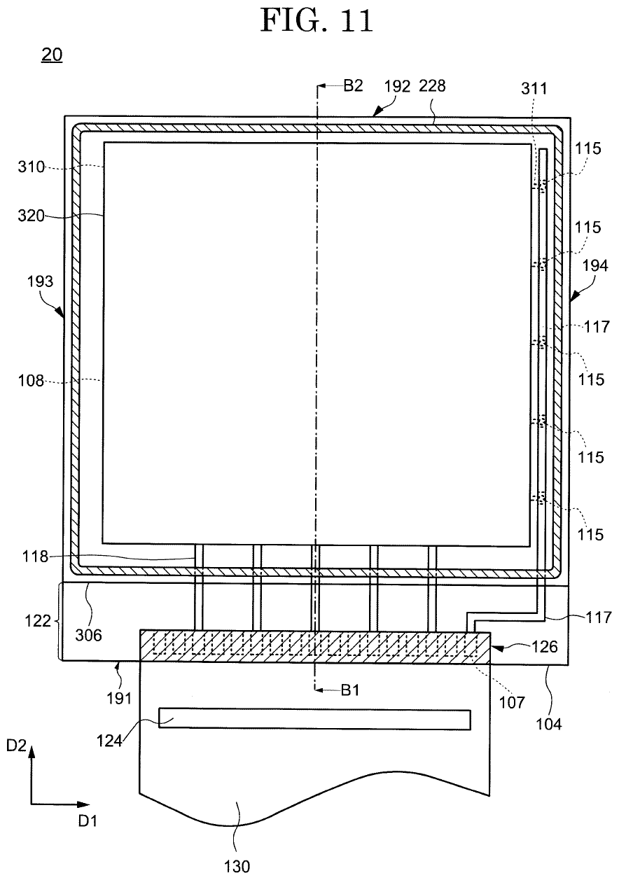

A radio wave absorption device 20 according to the second embodiment will be described with reference to FIG. 11 to FIG. 14. The radio wave absorption device 20 is a device having a function of absorbing radio waves by utilizing a change in the dielectric constant due to an alignment state of a liquid crystal, similar to the radio wave absorption device 10. The radio wave absorption device 20 is different from the configuration of the radio wave absorption device 10 in that it includes a configuration related to a second common electrode 310. Configurations other than the configuration related to the second common electrode 310 of the radio wave absorption device 20 are similar to those of the radio wave absorption device 10. Therefore, in the description of the radio wave absorption device 20, differences from the radio wave absorption device 10 will be mainly described, and the same configurations as those of the radio wave absorption device 10 will be described as necessary. Descriptions of the same or similar configurations as those in FIG. 1 to FIG. 10 will be omitted.

### 2-1. Configuration of Radio Wave Absorption Device 20

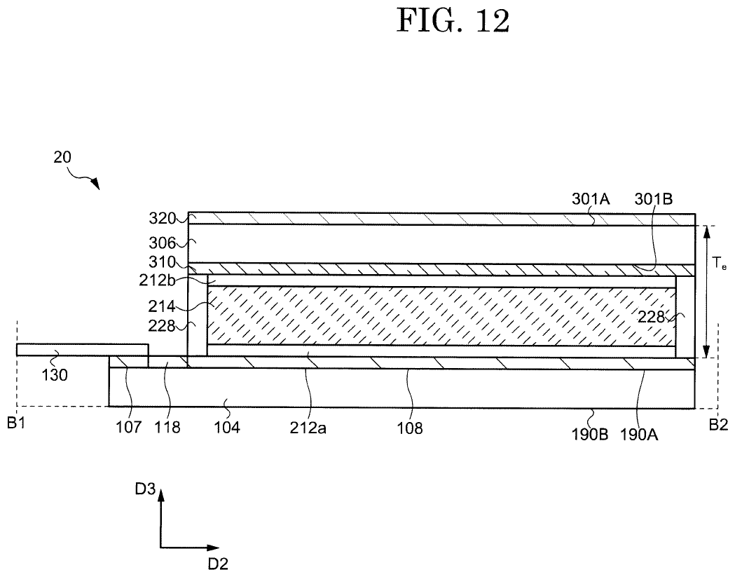

A configuration of the radio wave absorption device 20 will be described with reference to FIG. 11 and FIG. 12. FIG. 11 is a plan view showing a configuration of the radio wave absorption device 20. FIG. 12 is a cross-sectional view showing an example of a cross-sectional structure taken along a line B1-B2 shown in FIG. 11.

As shown in FIG. 11 or FIG. 12, the radio wave absorption device 20 includes a connection section 115, a common wiring 117, and the second common electrode 310. The second common electrode 210 is arranged on the second surface 301B of the counter substrate 306 and is connected to a plurality of common wirings 311 extending in the direction D1. In addition, the second common electrode 310 is sandwiched between the counter substrate 306 and an alignment film 121b. The plurality of common wirings 311 is arranged on the second surface 301B, similar to the second common electrode 210.

The plurality of common wirings 311 is electrically connected via a plurality of connection sections 115 to the common wiring 117 arranged in the dielectric substrate 104 at the second common electrode 310 (e.g., inside the sealing material 228 on the fourth side 194 side).

The common wiring 117 extends in the peripheral region 122 and is connected to the terminal section 126 (the terminal 107). A common voltage is supplied from the terminal section 126 via the common wiring 117 and the connection section 115 to the second common electrode 310. The second common electrode 310 may be referred to as a third electrode. For example, similar to the first embodiment, the common voltage may be the voltage COM, the GND voltage, the 0 V voltage, or the voltage VSS.

The second common electrode 310 and the common wiring 311 are formed using the same material as the first common electrode 320 of the radio wave absorption device 10. For example, the first common electrode 320, the second common electrode 310, and the common wiring 311 of the radio wave absorption device 20 are formed of the ITO. For example, the common wiring 117 is formed in the same layer as the bias electrode 108 of the radio wave absorption device 10 using the same material. For example, the connection section 115 may be an anisotropic conductive paste (ACP), such as a silver paste, or may be a plug using a metal material.

A glass substrate having light transmittance can be used as the dielectric substrate 104 and the counter substrate 306, and an ITO, which is a thin transparent conductive film, can be used as the first common electrode 320 and the second common electrode 310, so that the radio wave absorption device 20 can be made thin and transparent.

### 2-2. Example of Driving Method for Radio Wave Absorption Device 20

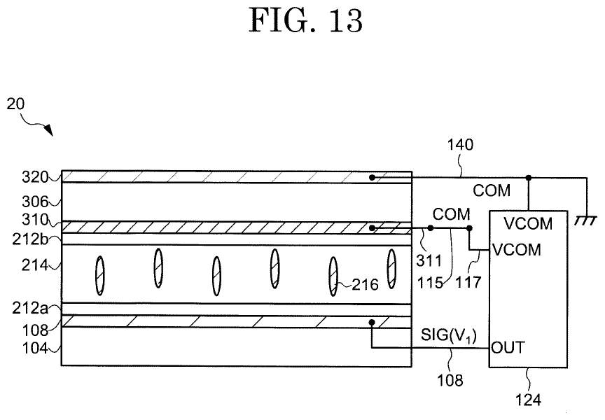

An example of a driving method for the radio wave absorption device 20 will be described with reference to FIG. 13. FIG. 13 is a diagram showing a state in which a voltage is applied between the bias electrode 108, the first common electrode 320, and the second common electrode 310 in the radio wave absorption device 20. Descriptions of the same or similar configurations as those in FIG. 1 to FIG. 12 will be omitted.

For example, the control circuit 124 includes the terminal VCOM and the terminal OUT. The terminal VCOM is electrically connected to the metal member 140 of the housing and the first common electrode 320, similar to the radio wave absorption device 10. In addition, the terminal VCOM is electrically connected to the second common electrode 310 via the common wiring 117, the plurality of connection sections 115, and the plurality of common wirings 311. The terminal OUT is electrically connected to the control signal line 118 and the bias electrode 108, similar to the radio wave absorption device 10. Similar to the radio wave absorption device 10, the terminal VCOM, the metal member 140 of the housing, and the first common electrode 320 are grounded and supplied with, for example, the voltage V₀ and the COM voltage. In addition, the terminal VCOM, the common wiring 117, the plurality of connection sections 115, the plurality of common wirings 311, and the second common electrode 31 are grounded and supplied with, for example, the voltage V₀ and the COM voltage. In addition, similar to the radio wave absorption device 10, the control circuit 124 transmits the control signal SIG (V₁) including the voltage V₁ to the control signal line 118 and the bias electrode 108.

That is, the driving method for the radio wave absorption device 20 includes supplying, for example, the COM voltage to the terminal VCOM, the metal member 140 of the housing, the first common electrode 320, and the second common electrode 310, and supplying the control signal SIG (V₁) including the voltage V₁ to the bias electrode 108.

In addition, similar to the radio wave absorption device 10, the radio wave absorption device 20 includes the metal member 140 of the housing, and the metal member 140 of the housing sandwiches the first common electrode 320 and the second surface 190B.

For example, in the process of manufacturing the radio wave absorber, a frequency absorbed by the radio wave absorber may deviate from a predetermined frequency according to manufacturing variations of a member forming the radio wave absorber. On the other hand, the radio wave absorption device 20 can adjust the voltage supplied to the first common electrode 320, the second common electrode 310 (the common wiring 117, the plurality of connection sections 115, and the plurality of common wirings 311), and the bias electrode 108 (the control signal line 118), adjust the frequency of the radio wave to be absorbed, and correct manufacturing variations (errors).

### 2-3. Equivalent Circuit of Radio Wave Absorption Device 20

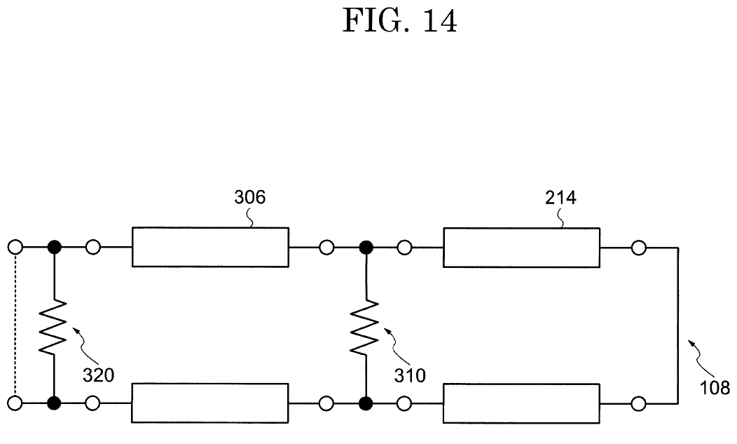

An equivalent circuit of the radio wave absorption device 20 will be described with reference to FIG. 14. FIG. 4 is an equivalent circuit diagram of the radio wave absorption device 20. In addition, descriptions of the same or similar configurations as those in FIG. 1 to FIG. 13 may be omitted.

The equivalent circuit of the radio wave absorption device 20 is different from the equivalent circuit of the radio wave absorption device 10 in that it includes an impedance of the second common electrode 310.

The radio wave absorption device 20 includes the second common electrode 310 sandwiched between the counter substrate 306 and the alignment film 121b. As described in “2-2. Example of Driving Method for Radio Wave Absorption Device 20”, the driving method for the radio wave absorption device 20 includes supplying, for example, the COM voltage to the first common electrode 320 and the second common electrode 310, and supplying the control signal SIG (V₁) including the voltage V₁ to the bias electrode 108. The voltage supplied to the second common electrode 310 is referred to as a third voltage.

The two electrodes sandwiching the liquid crystal layer 214, which is a variable dielectric, can be considered as the second common electrode 310 and the bias electrode 108 that are arranged closer to the liquid crystal layer 214. That is, the radio wave absorption device 20 can make the distance between the two electrodes sandwiching the liquid crystal layer 214 narrower (shorter) than in the radio wave absorption device 10. Therefore, in the driving method for the radio wave absorption device 20, the distance between the two electrodes sandwiching the liquid crystal layer 214 is narrowed, thereby adjusting the thickness Tₑ of the radio wave absorption device 20 to a predetermined thickness by supplying a small voltage.

For example, in the driving method of the radio wave absorption device 20, the thickness Tₑ₁ of the radio wave absorption device 20 can be adjusted to λ/4 (Tₑ₁=λ/4) by supplying the control signal SIG (V₁) including the voltage V₁ smaller than that of the radio wave absorption device 10.

The configurations of the radio wave absorption device and the configurations of the driving method for the radio wave absorption device exemplified as an embodiment of the present invention can be combined as long as there is no contradiction. In addition, the configurations of the radio wave absorption device and the configurations of the driving method for the radio wave absorption device exemplified as an embodiment of the present invention can be interchanged as long as there is no contradiction. Further, the addition, deletion, or design change of components, or the addition, deletion, or condition change of processes as appropriate by those skilled in the art based on the radio wave absorption device and the driving method for the radio wave absorption device are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A radio wave absorption device comprising:
a first substrate including a first surface and a second surface opposite the first surface;
a first electrode arranged on the first surface;
a second substrate including a third surface and a fourth surface opposite the third surface;
a second electrode arranged on the third surface;
a liquid crystal layer arranged between the first electrode and the fourth surface; and
a control circuit configured to supply a first voltage to the first electrode, a second voltage to the second electrode, and adjustably to control propagation lengths of radio waves to be absorbed according to the first voltage and the second voltage.

2. The radio wave absorption device according to claim 1, wherein
the first voltage is higher than the second voltage, and
the first voltage is higher than a voltage at which the liquid crystal layer begins to align.

3. The radio wave absorption device according to claim 1, further comprising
a metal member in contact with the second electrode and sandwiching the second electrode and the second surface.

4. The radio wave absorption device according to claim 3, wherein
the metal member is electrically connected to a terminal supplying the second voltage.

5. The radio wave absorption device according to claim 1, wherein
a distance between the first electrode and the second electrode is one-fourth of the wavelength λ.

6. The radio wave absorption device according to claim 1, wherein
the first electrode includes a material reflecting radio waves.

7. The radio wave absorption device according to claim 6, further comprising
a sealing material surrounding the liquid crystal layer and arranged between the first substrate and the second substrate, wherein
the first electrode is arranged so as to overlap the liquid crystal layer at least on the first surface inside the sealing material.

8. The radio wave absorption device according to claim 1, further comprising
a third electrode disposed on the fourth surface.

9. The radio wave absorption device according to claim 8, wherein
the control circuit is configured to supply a third voltage identical to the second voltage to the third electrode.

10. A driving method for radio wave absorption device,
the radio wave absorption device comprising:
a first substrate including a first surface and a second surface opposite the first surface;
a first electrode arranged on the first surface;
a second substrate including a third surface and a fourth surface opposite the third surface;
a second electrode arranged on the third surface;
a liquid crystal layer arranged between the first electrode and the fourth surface; and
the driving method comprising:
supplying a first voltage to the first electrode;
supplying a second voltage lower than the first voltage to the second electrode; and
adjusting the propagation length of the radio wave of the predetermined frequency according to the first voltage and the second voltage.
